(19) United States
(12) Patent Application Publication
(10) Pub. No.: US 2020/0393593 A1
(43) Pub. Date: Dec. 17, 2020

(54) INTEGRATED SYSTEM FOR GEOLOGICAL AND GEOPHYSICAL SURVEY BASED ON UNMANNED AERIAL VEHICLE

(71) Applicant: China University of Geosciences, Beijing, Beijing (CN)

(72) Inventors: Rongyi QIAN, Beijing (CN); Jian LI, Beijing (CN)

(21) Appl. No.: 16/903,909

(22) Filed: Jun. 17, 2020

(30) Foreign Application Priority Data
Jun. 17, 2019 (CN) 201910521042.2

(51) Int. Cl. G01V 3/165; G06K 9/62; B64C 39/02

(52) U.S. Cl. CPC G01V 3/165; B64C 2201/123; B64C 39/024; G06K 9/6256

(57) ABSTRACT

An example of the present invention provides an integrated system for geological and geophysical survey based on an unmanned aerial vehicle (UAV), including a positioning unit, a magnetic survey unit, a data acquisition unit, an attitude acquisition unit, and a processing unit, where the positioning unit, the magnetic survey unit, the data acquisition unit, and the attitude acquisition unit are connected to the processing unit; the positioning unit is configured to acquire a current location of the UAV in real time; and the processing unit is configured to obtain current magnetic survey data, current geological and geophysical data, and current attitude data respectively acquired by the magnetic survey unit, the data acquisition unit, and the attitude acquisition unit, when the current location of the UAV is a preset detection point.

### TECHNICAL FIELD

The present invention relates to the technical field of geological and geophysical survey, and in particular, to an integrated system for geological and geophysical survey based on an unmanned aerial vehicle (UAV).

### BACKGROUND

As an important method for geological and geophysical survey, the geological and geophysical survey based on UAV acquires data including various geological and geophysical information in a non-contact way through instruments carried by UAVs to study the distribution of geological structures, mineral resources, or other objects. This method can overcome the adverse factors brought by the natural environment for the geological and geophysical survey.

Most of the UAVs currently used in the geological and geophysical survey carry only one type of instrument to acquire a single type of data, with a low spatial sampling rate and a small amount of data acquired. During the actual data acquisition, field work often requires a plurality of independent instruments to carry out various tasks such as aeromagnetic survey and geographic surveying and mapping. If a plurality of UAVs are used to carry the corresponding instruments, cooperation between them becomes difficult. If a same UAV is used, the disassembly operation is cumbersome, which does not meet the efficient geological and geophysical survey requirements; the working status of each instrument cannot be fed back in real time, and the accuracy of the fixed-point measurement is not high enough, which often leads to poor data quality and even serious consequences such as rework.

Therefore, how to enrich the types of data acquired in the geological and geophysical survey based on UAVs and improve the data acquisition efficiency remains an urgent issue to be solved by those skilled in the art.

### SUMMARY

Examples of the present invention provide an integrated system for geological and geophysical survey based on a UAV to solve the problem that only limited types of data can be acquired in the conventional geological and geophysical survey based on a UAV.

The present invention provides an integrated system for geological and geophysical survey based on a UAV, including a positioning unit, a magnetic survey unit, a data acquisition unit, an attitude acquisition unit, and a processing unit, where the positioning unit, the magnetic survey unit, the data acquisition unit, and the attitude acquisition unit are connected to the processing unit; the positioning unit is configured to acquire a current location of the UAV in real time; and the processing unit is configured to obtain current magnetic survey data, current geological and geophysical data, and current attitude data respectively acquired by the magnetic survey unit, the data acquisition unit, and the attitude acquisition unit, when the current location of the UAV is a preset detection point.

The present invention further provides an integrated system for geological and geophysical survey based on a UAV. One UAV is equipped with a magnetic survey unit, a data acquisition unit, and an attitude acquisition unit at the same time, and uses a processing unit to acquire current magnetic survey data, current geological and geophysical data, and current attitude data of a same location. These can improves the integration of the units, so that different types of geological and geophysical survey data can be obtained in one flight, and different types of data acquired at the same location can be stored and processed in a unified manner, effectively reducing data processing errors and the interpretation multiplicity and implementing efficient acquisition of geological and geophysical survey data.

### BRIEF DESCRIPTION OF DRAWINGS

To describe the technical solutions in the examples of the present invention or in the prior art more clearly, the following briefly introduces the accompanying drawings required for describing the examples or the prior art. Apparently, the accompanying drawings in the following description show some examples of the present invention, and a person of ordinary skill in the art may still derive other drawings from these accompanying drawings without creative efforts.

FIG. 1 is a schematic structural diagram of an integrated system for geological and geophysical survey based on a UAV according to an example of the present invention.

FIG. 2 is a schematic diagram of a fluctuation flight of a UAV for geological and geophysical survey according to an example of the present invention.

### REFERENCE NUMERALS

210—UAV; 220—flight path; 230—terrain.

### DETAILED DESCRIPTION

In order to make the objectives, technical solutions and advantages of the examples of the present invention clearer, the following clearly and completely describes the technical solutions in the examples of the present invention with reference to accompanying drawings in the examples of the present invention. Apparently, the described examples are some rather than all of the examples. All other examples obtained by a person of ordinary skill in the art based on the examples of the present invention without creative efforts shall fall within the protection scope of the present invention. All other examples obtained by a person of ordinary skill in the art based on the examples of the present invention without creative efforts shall fall within the protection scope of the present invention.

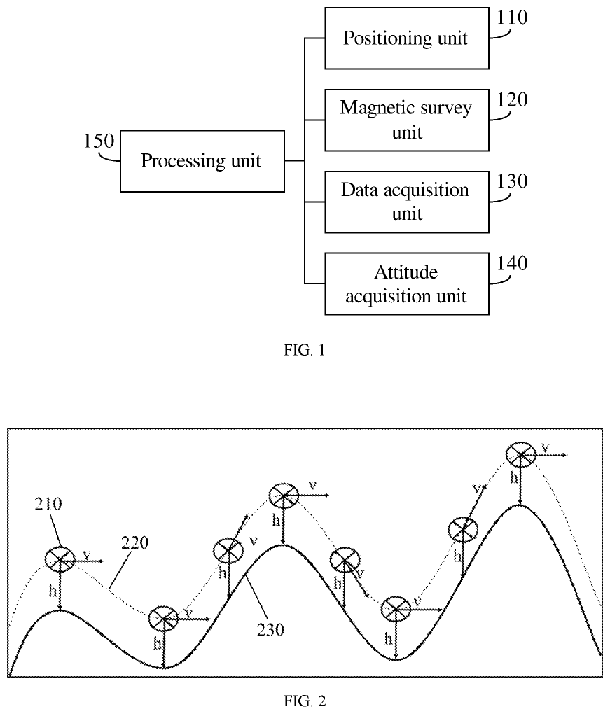

Most of the UAVs currently used in the geological and geophysical survey carry only one type of instrument to acquire a single type of data, with a low spatial sampling rate and a small amount of acquired data. This cannot meet the needs of the geological and geophysical survey. Therefore, an example of the present invention provides an integrated system for geological and geophysical survey based on a UAV. FIG. 1 is a schematic structural diagram of an integrated system for geological and geophysical survey based on a UAV according to an example of the present invention. As shown in FIG. 1, the system includes a positioning unit 110, a magnetic survey unit 120, a data acquisition unit 130, an attitude acquisition unit 140, and a processing unit 150. The positioning unit 110, the magnetic survey unit 120, the data acquisition unit 130, and the attitude acquisition unit 140 are connected to the processing unit 150. The positioning unit 110 is configured to acquire a current location of the UAV in real time. The processing unit 150 is configured to obtain current magnetic survey data, current geological and geophysical data, and current attitude data respectively acquired by the magnetic survey unit 120, the data acquisition unit 130, and the attitude acquisition unit 140, when the current location of the UAV is a preset detection point.

Specifically, the UAV is used for geological and geophysical survey, and loaded with the positioning unit 110, the magnetic survey unit 120, the data acquisition unit 130, the attitude acquisition unit 140, and the processing unit 150. The positioning unit 110 is configured to position the UAV in real time and obtain the current location of the UAV. The positioning unit 110 may be a GPS system. The magnetic survey unit 120 is configured to acquire magnetic survey data. The magnetic survey unit 120 may be a magnetometer or any other device that can be used to acquire magnetic survey data. The magnetic survey data is a magnetic field value of a target area acquired by the magnetic survey device. The data acquisition unit 130 is configured to acquire geological and geophysical data. The data acquisition unit 130 may be a commonly used UAV lidar system, an airborne oblique photography system, an airborne image transmission system, or any other geological and geophysical survey acquisition tool that can be loaded on the UAV. The geological and geophysical data is the various geological and geophysical data acquired by the acquisition devices loaded on the UAV. The geological and geophysical data may be presented in one or more forms such as images, videos, or data tables. This is not specifically limited in the examples of the present invention. The attitude acquisition unit 140 is configured to acquire attitude data. The attitude acquisition unit 140 may be a gyroscope capable of acquiring an angular velocity of the UAV, an accelerometer capable of acquiring the acceleration of the UAV, or the like, and the attitude data may be the angular velocity, the acceleration, or the like of the UAV, which are not specifically limited in the examples of the present invention.

In the integrated system, the processing unit 150 is connected to the positioning unit 110, the magnetic survey unit 120, the data acquisition unit 130, and the attitude acquisition unit 140. During the geological and geophysical survey performed by the UAV, the positioning unit 110 acquires the current location of the UAV in real time, and transmits the acquired current location to the processing unit 150 in real time. After receiving the current location, the processing unit 150 matches it with the preset detection point. The preset detection point herein is a preset location for geological and geophysical survey. If the current location is the preset detection point, the processing unit 150 obtains the magnetic survey data of the current location acquired by the magnetic survey unit 120 in real time through the magnetic survey unit 120, that is, the current magnetic survey data; obtains the geological and geophysical data of the current location acquired by the data acquisition unit 130 in real time through the data acquisition unit 130, that is, the current geological and geophysical data; and obtains the attitude data of the current location acquired by the attitude acquisition unit 140 in real time through the attitude acquisition unit 140, that is, the current attitude data. The foregoing current magnetic survey data, current geological and geophysical data, and current attitude data are all data acquired in the same location at the same time.

In the system provided by the present invention, one UAV is equipped with a magnetic survey unit, a data acquisition unit, and an attitude acquisition unit at the same time, and uses a processing unit to acquire current magnetic survey data, current geological and geophysical data, and current attitude data of a same location. This improves the integration of the units, so that different types of geological and geophysical survey data can be obtained in one flight, and different types of data acquired in the same location can be stored and processed in a unified manner, effectively reducing data processing errors and the interpretation multiplicity and implementing efficient acquisition of geological and geophysical survey data.

Based on this example, the system further includes a magnetic survey coupling unit, where the magnetic survey coupling unit is connected to the processing unit, and the magnetic survey coupling unit is configured to denoise the current magnetic survey data and return the denoised current magnetic survey data to the processing unit.

Specifically, most existing UAV systems are mechanical combinations. Instruments and equipment such as UAVs contain ferromagnetic substances, which cause fixed magnetic interference. The ferromagnetic substances contained in the UAV system cut the geomagnetic field, and the rotation of a motor of the UAV produces strong induction electromagnetic field interference, which affects the accuracy of the magnetic survey. Therefore, the current magnetic survey data directly acquired by the magnetic survey unit may have a large amount of interference data.

After obtaining the current magnetic survey data and current attitude data corresponding to the same preset detection point, the processing unit sends the current magnetic survey data and the current attitude data to the magnetic survey coupling unit. After receiving the current magnetic survey data and the current attitude data, the magnetic survey coupling unit denoises the current magnetic survey data directly acquired by the magnetic survey unit based on the current attitude data, so as to filter out the magnetic interference caused to the magnetic survey unit by the ferromagnetic substances in the instruments and equipment such as the UAV during the data acquisition process. The denoised current magnetic survey data can reflect an actual magnetic field value of the preset detection point.

In the system provided by the present invention, the magnetic survey coupling unit denoises the current magnetic survey data based on the current attitude data. This solves the problems of poor accuracy and low precision of the acquired magnetic survey data due to the magnetic interference generated by the ferromagnetic substances in the magnetic survey unit or other instruments, improves the magnetic survey accuracy of the UAV and provides reliable data support for accurate judgment of geological and geophysical status.

Based on any of the above examples, the magnetic survey coupling unit includes a mode determining subunit, a magnetic interference obtaining subunit, and a coupling subunit, where the mode determining subunit is configured to determine a flight mode of the UAV based on the current attitude data; the magnetic interference obtaining subunit is configured to obtain a magnetic interference value corresponding to the flight mode based on the flight mode and a preset relationship between flight modes and magnetic interference values; and the coupling subunit is configured to denoise the current magnetic survey data based on the magnetic interference value and return the denoised current magnetic survey data to the processing unit.

Specifically, after the magnetic survey coupling unit receives the current magnetic survey data and the current attitude data, the mode determining subunit in the magnetic survey coupling unit determines the flight mode of the UAV according to the current data. The flight mode herein may be divided in terms of the flying speed, flight attitude, or the like of the UAV. For example, the flight mode may be low-speed flight, high-speed flight, direct flight, low-altitude flight, or the like, which is not specifically limited in the examples of the present invention.

Then, the mode determining subunit in the magnetic survey coupling unit transmits the flight mode to the magnetic interference obtaining subunit. The relationship between flight modes and magnetic interference values is pre-stored in the magnetic interference obtaining subunit. The magnetic interference obtaining subunit can directly obtain a magnetic interference value corresponding to the flight mode based on the relationship between flight modes and magnetic interference values.

Then, the magnetic interference obtaining subunit in the magnetic survey coupling unit transmits the magnetic interference value to the coupling subunit. After receiving the magnetic interference value, the coupling subunit subtracts the magnetic interference value from the current magnetic survey data to denoise the current magnetic survey, and then returns the denoised current magnetic survey data to the processing unit.

In the system provided by the present invention, the magnetic survey coupling unit determines the flight mode based on the current attitude data, and further obtains the magnetic interference value corresponding to the flight mode, based on which the magnetic survey data is denoised. This provides a simple and effective way for denoising.

Based on any of the above examples, the system further includes a fluctuation flight unit and a flight control unit, where the processing unit is connected to the fluctuation flight unit and the flight control unit; the fluctuation flight unit is configured to input the current location and current geological and geophysical data transmitted by the processing unit into a path prediction model to obtain fluctuation flight data output by the path prediction model, where the path prediction model is obtained through training based on sample locations, sample geological and geophysical data, and sample fluctuation flight data; and the flight control unit is configured to control the flight of the UAV based on the fluctuation flight data.

Specifically, the conventional UAV-based geological and geophysical survey technologies mostly implement fixed-altitude flight for UAVs. In this case, the flying height of the UAVs must be increased at the cost of the survey accuracy, so as to ensure the secure flight of the UAVs. In the present invention, the fluctuation flight of the UAV is realized through the fluctuation flight unit and the flight control unit.

After the geological and geophysical survey data is obtained, the fluctuation flight unit inputs the current location and current geological and geophysical data into the pre-trained path prediction model. The path prediction model is used to generate fluctuation flight data for instructing the UAV to fly along the terrain reflected by the current geological and geophysical data based on the input current location and current geological and geophysical data. FIG. 2 is a schematic diagram of a fluctuation flight of a UAV for geological and geophysical survey according to an example of the present invention. In FIG. 2, a solid line represents a terrain 230, and a dotted line above the solid line represents a flight path 220 of the UAV. Under the same abscissa, a difference between the flight path 220 of the UAV 210 and the terrain 230 in the vertical direction is constantly h, where h is used to indicate a preset fluctuation flying height, and v represents a flying speed of the UAV. Herein, the fluctuation flight data is used to instruct the UAV to fly along the terrain reflected by current geological and geophysical data. The fluctuation flight data may include a flight attitude, a flying speed, a flying direction, or the like of the UAV at a next moment or period, which is not specifically limited in the examples of the present invention.

In addition, a path prediction model stored in the fluctuation flight unit may be obtained through training as follows: First, a large amount of sample locations, sample geological and geophysical data, and sample fluctuation flight data are acquired. The sample locations and sample geological and geophysical data are the location and geological and geophysical data corresponding to a same preset detection point acquired by the UAV through the positioning unit and the data acquisition unit during the geological and geophysical survey process. The sample fluctuation flight data is the flight data of the UAV flying along the terrain reflected by the sample geological and geophysical data. The sample fluctuation flight data may be flight data of the UAV controlled to fly along the actual terrain by an operator according to a three-dimensional space model generated based on the sample locations and sample geological and geophysical data during the geological and geophysical survey of the UAV. It should be noted that there is a one-to-one correspondence between the sample location, sample geological and geophysical data, and sample fluctuation flight data. Then, an initial model is trained based on the sample locations, sample geological and geophysical data, and sample fluctuation flight data, to obtain the path prediction model. The initial model may be a single neural network model or a combination of multiple neural network models. The examples of the present invention do not specifically limit a type and a structure of the initial model.

After obtaining the fluctuation flight data, the fluctuation flight unit returns the fluctuation flight data to the processing unit. After receiving the fluctuation flight data, the processing unit returns the fluctuation flight data to the flight control unit. After receiving the fluctuation flight data, the flight control unit controls the flight of the UAV based on the fluctuation flight data, so that the UAV can fly along the terrain.

The system provided by the present invention inputs the geological and geophysical survey data into the path prediction model to obtain the fluctuation flight data to control the UAV to fly along the terrain. While ensuring the secure flight of the UAV, the system uses the AI technology to maintain a distance between the UAV and the surveyed surface within a preset range, which effectively improves the geological and geophysical survey accuracy of the UAV.

Based on any of the above examples, the fluctuation flight unit in the system is specifically configured to: input the current geological and geophysical data into a terrain recognition sub-model in the path prediction model to obtain terrain data output by the terrain recognition sub-model; and obtain the fluctuation flight data based on the current location, the terrain data, and the preset flying height.

Specifically, the path prediction model includes the terrain recognition sub-model. The terrain recognition sub-model is used to analyze and mine the input current geological and geophysical data to generate data for displaying the terrain reflected by the current geological and geophysical data, that is, terrain data.

The terrain recognition sub-model may be obtained through training as follows: First, a large amount of sample geological and geophysical data and sample terrain data are acquired. The sample geological and geophysical data is the geological and geophysical data acquired by the UAV through the data acquisition unit during the geological and geophysical survey, and the sample terrain data is used to reflect specific terrains contained in the sample geological and geophysical data. There is a one-to-one correspondence between the sample geological and geophysical data and the sample terrain data. Then, an initial model is trained based on the sample geological and geophysical data and sample terrain data, to obtain the terrain recognition sub-model. The initial model may be a single neural network model or a combination of multiple neural network models. The examples of the present invention do not specifically limit a type and a structure of the initial model.

The preset flight attitude is a preset flying height of the UAV based on the ground surface. After obtaining the terrain data, the fluctuation flight unit obtains the fluctuation flight data that can realize a smoothest flight path under the fluctuation terrain based on the current location, the terrain data, and the preset flying height, to ensure that the UAV can successfully avoid obstacles while maintaining the preset flying height from the ground surface to make accurate geological and geophysical surveys. For example, the terrain data is a terrain fluctuation curve. After the terrain fluctuation curve is obtained, the terrain fluctuation curve is raised to the preset flight attitude, and fluctuation flight data is determined based on the current location, a preset flight path, the raised flight curve, and a current flight orientation.

Based on any of the above examples, the system further includes a geological and geophysical recognition unit, where the geological and geophysical recognition unit is connected to the processing unit; and the geological and geophysical recognition unit is configured to input the current geological and geophysical data transmitted by the processing unit into a geological and geophysical recognition model, and obtain a recognition result output by the geological and geophysical recognition model, where the geological and geophysical recognition model is obtained through training based on the sample geological and geophysical data and sample geological and geophysical recognition results.

Specifically, the existing methods for geological and geophysical survey based on UAVs can hardly meet the needs of geological and geophysical survey, because these methods can only implement simple data acquisition and processing, but cannot deeply explore the acquired data or fully utilize the data. To solve this problem, the system in an example of the present invention is equipped with a geological and geophysical recognition unit.

The processing unit sends the current geological and geophysical data to the geological and geophysical recognition unit. After receiving the current geological and geophysical data, the geological and geophysical recognition unit inputs the current geological and geophysical data into a pre-trained geological and geophysical recognition model. The geological and geophysical recognition model is used for deep mining, analysis, and recognition of the input current geological and geophysical data to obtain geological and geophysical recognition results corresponding to the current geological and geophysical data. The geological and geophysical recognition result may include the topography and landform reflected by the current geological and geophysical data, the ground features reflected by the current geological and geophysical data, or the geological structure or geological lithology reflected by the current geological and geophysical data, which is not specifically limited in the examples of the present invention.

It should be noted that the geological and geophysical recognition model pre-stored in the geological and geophysical recognition unit may be obtained through training as follows: First, a large amount of sample geological and geophysical data and sample geological and geophysical recognition results are acquired. The sample geological and geophysical data is the geological and geophysical data acquired by the UAV through the data acquisition unit during the geological and geophysical survey, and the sample geological and geophysical recognition results are obtained by researchers by deeply mining the sample geological and geophysical data. There is a one-to-one correspondence between the sample geological and geophysical data and the sample geological and geophysical recognition results. Then, an initial model is trained based on the sample geological and geophysical data and sample geological and geophysical recognition results, to obtain the geological and geophysical recognition model. The initial model may be a single neural network model or a combination of multiple neural network models. The examples of the present invention do not specifically limit a type and a structure of the initial model.

The system provided by the present invention inputs the current geological and geophysical data into the geological and geophysical recognition model to obtain the geological and geophysical recognition results, and deeply mines the current geological and geophysical data acquired by the data acquisition unit loaded by the UAV. In this way, only training sample annotation needs to be performed manually, while the geological and geophysical recognition results are obtained by the AI technology, which saves manpower and material resources and effectively improves the utilization of the current geological and geophysical data. The needs of geological and geophysical survey can be met by using the UAV for survey, with no need to perform manual ground survey to supplement data. This reduces the cost of geological and geophysical survey and improves the survey efficiency.

Based on any of the above examples, the system further includes a modeling unit, where the modeling unit is connected to the geological and geophysical recognition unit; and the modeling unit is configured to construct a three-dimensional geological and geophysical model based on the geological and geophysical recognition results transmitted by the geological and geophysical recognition unit.

Specifically, after obtaining the geological and geophysical recognition results based on the geological and geophysical recognition model, the geological and geophysical recognition unit sends the geological and geophysical recognition results to the modeling unit. After receiving the geological and geophysical recognition results, the modeling unit can construct the three-dimensional geological and geophysical model based on the geological and geophysical recognition results. The three-dimensional geological and geophysical model can be constructed in multiple ways. For example, the surface and underground space information of the currently surveyed complex topographic and geomorphic regions are obtained based on the geological and geophysical recognition results, current geological and geophysical data, and data processing technologies, and a three-dimensional geological and geophysical model is constructed based on such information.

Based on any of the above examples, the system further includes a communication unit, where the communication unit is connected to the processing unit; and the communication unit is configured to send at least one of the current magnetic survey data, the current geological and geophysical data, and the current attitude data to a ground unit.

Specifically, the ground unit is a monitoring unit installed on the ground. The staff can monitor the flight status and geological and geophysical survey data of the UAV in real time through the ground unit. The integrated system for geological and geophysical survey based on a UAV establishes a connection between the airborne processing unit and the ground unit through the communication unit, to transmit the geological and geophysical survey data to the ground, such as the current magnetic survey data, the current geological and geophysical data, and the current attitude data. In addition, the communication unit can also transmit the data obtained by the airborne unit to the ground, such as the current location of the UAV obtained by the processing unit, the denoised current magnetic survey data, the fluctuation flight data, and the geological and geophysical recognition results. This is not specifically limited in the examples of the present invention.

Based on any of the above examples, in this system, the communication unit is further configured to transmit, to the processing unit, a control instruction sent by the ground unit.

Specifically, the staff can learn the current geological and geophysical survey status and the flight status of the UAV through the ground unit, and determine whether they meet the expectations, so as to determine whether manual intervention is required for the integrated system for geological and geophysical survey based on a UAV.

When manual intervention is required, the staff can send a control instruction through the ground unit. The control instruction herein may be data manually input by the staff to control the flight of the UAV, or may be an instruction for adjusting related parameters of the devices loaded on the UAV, which is not specifically limited in the examples of the present invention. After receiving the control instruction through the communication unit, the processing unit executes the control instruction.

The system provided by the present invention allows manual intervention by the staff through the communication unit, which makes the system control more free and flexible.

Based on any of the above examples, in this system, the data acquisition unit includes an airborne oblique photography system, an airborne image transmission system, and an airborne lidar system, where the airborne oblique photography system is configured to acquire current image data, the airborne image transmission system is configured to acquire current video data, and the airborne lidar system is configured to acquire current point cloud data; and correspondingly, the current geological and geophysical data includes the current image data, the current video data, and the current point cloud data.

Specifically, the airborne oblique photography system refers to a high-definition motion camera borne on the UAV. The high-definition motion camera can capture images from different angles such as vertical and oblique, and output image data. The airborne image transmission system refers to a high-definition motion camera borne on the UAV to acquire video data from the perspective of the aircraft. The airborne lidar system is a light detection and ranging (LiDAR) system that generates point cloud data corresponding to ground sampling points, including geometric features and spectral features, through measurement data and information processing. The airborne oblique photography system, airborne image transmission system, and airborne lidar system all can effectively obtain geological and geophysical data for geographic surveying and mapping. However, in complex fluctuation terrain and geomorphic areas, the data obtained by the three systems sometimes is incomplete, and the optimal geological and geophysical survey results cannot be achieved.

In the system provided by the present invention, the airborne oblique photography system, the airborne image transmission system, and the airborne lidar system are loaded on one UAV, to ensure that the data acquired by the different systems can make up for each other in complex fluctuation terrain areas, so that the relatively complete geological and geophysical data can be obtained and optimal geological and geophysical survey results can be achieved.

Finally, it should be noted that the foregoing examples are only used to explain the technical solutions of the present invention, and are not intended to limit the same. Although the present invention is described in detail with reference to the foregoing examples, those of ordinary skill in the art should understand that they can still modify the technical solutions described in the foregoing examples, or make equivalent substitutions on some technical features therein. These modifications or substitutions do not make the essence of the corresponding technical solutions deviate from the spirit and scope of the technical solutions of the examples of the present invention.

1. An integrated system for geological and geophysical survey based on an unmanned aerial vehicle (UAV), comprising a positioning unit, a magnetic survey unit, a data acquisition unit, an attitude acquisition unit, and a processing unit, wherein the positioning unit, the magnetic survey unit, the data acquisition unit, and the attitude acquisition unit are connected to the processing unit;
the positioning unit is configured to acquire a current location of the UAV in real time; and
the processing unit is configured to obtain current magnetic survey data, current geological and geophysical data, and current attitude data respectively acquired by the magnetic survey unit, the data acquisition unit, and the attitude acquisition unit, when the current location of the UAV is a preset detection point.

2. The integrated system for geological and geophysical survey based on a UAV according to claim 1, further comprising a magnetic survey coupling unit, wherein the magnetic survey coupling unit is connected to the processing unit; and
the magnetic survey coupling unit is configured to denoise the current magnetic survey data and return the denoised current magnetic survey data to the processing unit.

3. The integrated system for geological and geophysical survey based on a UAV according to claim 2, wherein the magnetic survey coupling unit comprises a mode determining subunit, a magnetic interference obtaining subunit, and a coupling subunit, wherein
the mode determining subunit is configured to determine a flight mode of the UAV based on the current attitude data; the magnetic interference obtaining subunit is configured to obtain a magnetic interference value corresponding to the flight mode based on the flight mode and a preset relationship between flight modes and magnetic interference values; and the coupling subunit is configured to denoise the current magnetic survey data based on the magnetic interference value and return the de-noised current magnetic survey data to the processing unit.

4. The integrated system for geological and geophysical survey based on a UAV according to claim 1, further comprising a fluctuation flight unit and a flight control unit, wherein
the processing unit is connected to the fluctuation flight unit and the flight control unit;
the fluctuation flight unit is configured to input the current location and current geological and geophysical data transmitted by the processing unit into a path prediction model to obtain fluctuation flight data output by the path prediction model, wherein the path prediction model is obtained through training based on sample locations, sample geological and geophysical data, and sample fluctuation flight data; and
the flight control unit is configured to control the flight of the UAV based on the fluctuation flight data.

5. The integrated system for geological and geophysical survey based on a UAV according to claim 4, wherein the fluctuation flight unit is specifically configured to:
input the current geological and geophysical data into a terrain recognition sub-model in the path prediction model to obtain terrain data output by the terrain recognition sub-model; and
obtain the fluctuation flight data based on the current location, the terrain data, and a preset flying height.

6. The integrated system for geological and geophysical survey based on a UAV according to claim 1, further comprising a geological and geophysical recognition unit, wherein the geological and geophysical recognition unit is connected to the processing unit; and
the geological and geophysical recognition unit is configured to input the current geological and geophysical data transmitted by the processing unit into a geological and geophysical recognition model, and obtain a recognition result output by the geological and geophysical recognition model, wherein the geological and geophysical recognition model is obtained through training based on the sample geological and geophysical data and sample geological recognition results.

7. The integrated system for geological and geophysical survey based on a UAV according to claim 6, further comprising a modeling unit, wherein the modeling unit is connected to the geological and geophysical recognition unit; and
the modeling unit is configured to construct a three-dimensional geological and geophysical model based on the geological and geophysical recognition result transmitted by the geological and geophysical recognition unit.

8. The integrated system for geological and geophysical survey based on a UAV according to claim 1, further comprising a communication unit, wherein the communication unit is connected to the processing unit; and
the communication unit is configured to send at least one of the current magnetic survey data, the current geological and geophysical data, and the current attitude data to a ground unit.

9. The integrated system for geological and geophysical survey based on a UAV according to claim 2, further comprising a communication unit, wherein the communication unit is connected to the processing unit; and
the communication unit is configured to send at least one of the current magnetic survey data, the current geological and geophysical data, and the current attitude data to a ground unit.

10. The integrated system for geological and geophysical survey based on a UAV according to claim 3, further comprising a communication unit, wherein the communication unit is connected to the processing unit; and
the communication unit is configured to send at least one of the current magnetic survey data, the current geological and geophysical data, and the current attitude data to a ground unit.

11. The integrated system for geological and geophysical survey based on a UAV according to claim 4, further comprising a communication unit, wherein the communication unit is connected to the processing unit; and
the communication unit is configured to send at least one of the current magnetic survey data, the current geological and geophysical data, and the current attitude data to a ground unit.

12. The integrated system for geological and geophysical survey based on a UAV according to claim 5, further comprising a communication unit, wherein the communication unit is connected to the processing unit; and
the communication unit is configured to send at least one of the current magnetic survey data, the current geological and geophysical data, and the current attitude data to a ground unit.

13. The integrated system for geological and geophysical survey based on a UAV according to claim 6, further comprising a communication unit, wherein the communication unit is connected to the processing unit; and
the communication unit is configured to send at least one of the current magnetic survey data, the current geological and geophysical data, and the current attitude data to a ground unit.

14. The integrated system for geological and geophysical survey based on a UAV according to claim 7, further comprising a communication unit, wherein the communication unit is connected to the processing unit; and
the communication unit is configured to send at least one of the current magnetic survey data, the current geological and geophysical data, and the current attitude data to a ground unit.

15. The integrated system for geological and geophysical survey based on a UAV according to claim 8, wherein the communication unit is further configured to transmit, to the processing unit, a control instruction sent by the ground unit.

16. The integrated system for geological and geophysical survey based on a UAV according to claim 1, wherein the data acquisition unit comprises an airborne oblique photography system, an airborne image transmission system, and an airborne lidar system, wherein the airborne oblique photography system is configured to acquire current image data, the airborne image transmission system is configured to acquire current video data, and the airborne lidar system is configured to acquire current point cloud data; and
correspondingly, the current geological and geophysical data comprises the current image data, the current video data, and the current point cloud data.

17. The integrated system for geological and geophysical survey based on a UAV according to claim 2, wherein the data acquisition unit comprises an airborne oblique photography system, an airborne image transmission system, and an airborne lidar system, wherein the airborne oblique photography system is configured to acquire current image data, the airborne image transmission system is configured to acquire current video data, and the airborne lidar system is configured to acquire current point cloud data; and
correspondingly, the current geological and geophysical data comprises the current image data, the current video data, and the current point cloud data.

18. The integrated system for geological and geophysical survey based on a UAV according to claim 3, wherein the data acquisition unit comprises an airborne oblique photography system, an airborne image transmission system, and an airborne lidar system, wherein the airborne oblique photography system is configured to acquire current image data, the airborne image transmission system is configured to acquire current video data, and the airborne lidar system is configured to acquire current point cloud data; and
correspondingly, the current geological and geophysical data comprises the current image data, the current video data, and the current point cloud data.

19. The integrated system for geological and geophysical survey based on a UAV according to claim 4, wherein the data acquisition unit comprises an airborne oblique photography system, an airborne image transmission system, and an airborne lidar system, wherein the airborne oblique photography system is configured to acquire current image data, the airborne image transmission system is configured to acquire current video data, and the airborne lidar system is configured to acquire current point cloud data; and
correspondingly, the current geological and geophysical data comprises the current image data, the current video data, and the current point cloud data.

20. The integrated system for geological and geophysical survey based on a UAV according to claim 5, wherein the data acquisition unit comprises an airborne oblique photography system, an airborne image transmission system, and an airborne lidar system, wherein the airborne oblique photography system is configured to acquire current image data, the airborne image transmission system is configured to acquire current video data, and the airborne lidar system is configured to acquire current point cloud data; and
correspondingly, the current geological and geophysical data comprises the current image data, the current video data, and the current point cloud data.
